(19) United States
(12) Patent Application Publication
(10) Pub. No.: US 2025/0367994 A1
(43) Pub. Date: Dec. 4, 2025

(54) DEVICE FOR AUTOMATICALLY ESTABLISHING CONNECTIONS BETWEEN A TRACTOR VEHICLE AND A TRAILER VEHICLE, AND A SYSTEM AND METHOD THEREFOR

(71) Applicant: ZF CV SYSTEMS GLOBAL GMBH, Bern (CH)

(72) Inventors: Oliver WULF, Neustadt (DE); Dennis SABELHAUS, Luhden (DE); Daniel HANSLIK, Isernhagen (DE)

(21) Appl. No.: 19/110,478

(22) PCT Filed: Sep. 7, 2023
(86) PCT No.: PCT/EP2023/074516

§ 371 Date: Mar. 11, 2025

(30) Foreign Application Priority Data
Sep. 15, 2022 (DE) 10 2022 123 660.9

(51) Int. Cl. B60D 1/64; B60T 7/20; B60T 13/68; B60T 17/22; B62D 53/12

(52) U.S. Cl. CPC B60D 1/64; B60T 7/20; B60T 13/683; B60T 17/22; B62D 53/125

(57) ABSTRACT

A device for automatically establishing electrical and pneumatic connections between a towing and a trailer vehicle, including a pneumatic cylinder having a vehicle end configured for connecting to a part of the towing vehicle, and having a plug connector end configured for connecting to a plug connector unit. The pneumatic cylinder has a coupling and a release state and a piston of the pneumatic cylinder is extended further out of a cylinder of the pneumatic cylinder in the coupling state than in the release state. The device includes a valve arrangement configured for connecting a first chamber of the pneumatic cylinder to a compressed air supply to shift from the release state to the coupling state, and configured for connecting a second chamber of the pneumatic cylinder to the compressed air supply to shift the pneumatic cylinder from the coupling state to the release state.

### CROSS REFERENCE TO RELATED APPLICATIONS

This application is a U.S. National Phase application under 35 U.S.C. § 371 of International Application No. PCT/EP2023/074516, filed on Sep. 7, 2023, and claims benefit to German Patent Application No. DE 10 2022 123 660.9, filed on Sep. 15, 2022. The International Application was published in German on Mar. 21, 2024 as WO 2024/056495 A1 under PCT Article 21(2).

### FIELD

The present disclosure relates to a device for automatically establishing connections between a towing vehicle and a trailer vehicle, and a system and method therefor.

The present disclosure also relates to the field of commercial vehicles and, in particular, towing vehicles designed as commercial vehicles.

### BACKGROUND

According to the prior art, when a trailer vehicle is coupled to, or uncoupled from, a towing vehicle, a plurality of connections is established in the vast majority of cases. It is customary to initially establish a mechanical connection, which can also be called a towing connection, between the towing vehicle and the trailer vehicle by way of a coupling. In the case of a towing vehicle designed as a tractor unit, the part of the coupling of the towing vehicle comprises a fifth-wheel plate. Such a fifth-wheel plate has an insertion region and a holding region. A kingpin of a trailer vehicle designed as a semitrailer can be pushed in via the insertion region until it reaches the holding region of the fifth-wheel plate. The kingpin is then coupled, i.e. locked, in the holding region.

In addition to this towing connection, other connections, namely pneumatic and electrical connections, are to be established between the towing vehicle and the trailer vehicle in order to allow different functions of an articulated lorry, made up of the towing vehicle and trailer vehicle, to be performed and to render the articulated lorry ready for driving. It is customary to establish two pneumatic connections which serve to activate, by means of the towing vehicle, the air brake in the trailer vehicle. One of the pneumatic connections corresponds to a supply line in order to transmit compressed air from the towing vehicle to the trailer vehicle. The other pneumatic connection serves as a control line in order to activate the brakes of the trailer vehicle on the basis of a control pressure specified by the towing vehicle.

It is likewise customary to establish electrical connections, generally two standardized plug connections, between the towing vehicle and the trailer vehicle in order to activate, by means of the towing vehicle, the electrical systems of the trailer vehicle and also, particularly in the case of modern trailer vehicles, to exchange information between the trailer vehicle and the towing vehicle.

It is customary for all these connections to be established, and also disconnected, manually by a driver. Partially automated methods for establishing the towing connections in the region of the fifth-wheel coupling are known. For example, the kingpin can be locked in place or released from the holding region of the fifth-wheel coupling, for example from the driver's cab. However, it is still necessary for the driver to manually establish the further plug connections, namely the pneumatic and electrical connections, between the towing vehicle and the trailer vehicle.

However, particularly in the field of autonomous driving, which is becoming increasingly significant, it is desirable also to implement the electrical and pneumatic connections between the towing vehicle and trailer vehicle automatically, i.e. without manual intervention by a driver. However, automatic connections of this type are neither known nor trivial to implement, and it is therefore still necessary for a person to establish the connections manually.

### SUMMARY

In an embodiment, the present disclosure provides a device for automatically establishing electrical and pneumatic connections between a towing vehicle and a trailer vehicle, comprising a pneumatic cylinder having a vehicle end configured for connecting to a part of the towing vehicle, and having a plug connector end configured for connecting to a plug connector unit. The pneumatic cylinder has a coupling state and a release state and a piston of the pneumatic cylinder is extended further out of a cylinder of the pneumatic cylinder in the coupling state than in the release state. The device further comprises a valve arrangement configured for connecting a first chamber of the pneumatic cylinder to a compressed air supply to shift from the release state to the coupling state, and configured for connecting a second chamber of the pneumatic cylinder to the compressed air supply to shift the pneumatic cylinder from the coupling state to the release state. The device further comprises a controller for activating the valve arrangement. The valve arrangement is configured to hold the pneumatic cylinder at least in the coupling state in the event of a failure of the controller.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an embodiment of a device for automatically establishing electrical and pneumatic connections between a towing vehicle and a trailer vehicle; and

FIG. 2 shows an embodiment of a method for automatically establishing electrical and pneumatic connections between a towing vehicle and a trailer vehicle.

### DETAILED DESCRIPTION

Embodiments of the present disclosure address the problems of the prior art. In particular, the process of establishing electrical and pneumatic connections between a towing vehicle and a trailer vehicle is to be automated. At least, an alternative to the prior art is provided.

The present disclosure relates to a device for automatically establishing electrical and pneumatic connections between a towing vehicle and a trailer vehicle. A towing vehicle designed as a commercial vehicle serves to tow a trailer vehicle designed as a commercial vehicle. The towing vehicles referred to in the present disclosure are preferably tractor units and the trailer vehicles referred to in the present disclosure are preferably semitrailers.

The present disclosure relates to a device and a method for automatically establishing electrical and pneumatic connections between a towing vehicle and a trailer vehicle. The device comprises a pneumatic cylinder having a vehicle end and a plug connector end. The vehicle end serves to connect to a part of the towing vehicle, and the plug connector end serves to connect to a plug connector unit. A part of the towing vehicle is, for example, a part which is arranged in the region of the fifth-wheel plate of the towing vehicle and is configured as a receptacle for attaching the cylinder. In the present disclosure, a plug connector unit comprises at least one plug connector, but preferably comprises a plurality of plug connectors. A plug connector can be designed as a plug or a socket.

A plug connector is, for example, an electrical plug connector, for example in accordance with ISO 11446, ISO 7638-2, ISO 1724, ISO 3732, ISO 12098, ISO 7638-1, ISO 1185 or ISO 3731. Accordingly, plug connectors of this type preferably comprise seven to fifteen pins and are designed as circular connectors. A plug connector or a further plug connector can also be provided as a pneumatic plug connector in order, when connected, to transmit compressed air, in particular from an air brake system, between the towing vehicle and the trailer vehicle. Particularly preferably, a plug connector unit, which is connectable, or in particular connected, to the plug connector end, comprises two pneumatic plug connectors and two electrical plug connectors.

A plug connector unit is further configured to be connected to a trailer plug connector unit, i.e. a further plug connector unit of the trailer vehicle. By connecting the plug connector unit to the trailer plug connector unit, compressed air from the towing vehicle can be transmitted to the trailer vehicle and electrical signals and/or data can be exchanged between the trailer vehicle and the towing vehicle.

According to the present disclosure, the pneumatic cylinder has a coupling state and a release state. In the coupling state, a piston of the pneumatic cylinder is extended further out of a cylinder of the pneumatic cylinder than in the release state. That is to say, the pneumatic cylinder comprises a cylinder with a piston which is movable therein. The piston can be moved, i.e. it can be retracted into the cylinder or extended out of the cylinder, by compressed air. For this purpose, two chambers are provided in the pneumatic cylinder, wherein pressurizing one of the chambers with air at a pressure which is higher than the air pressure in the other chamber causes the piston to move in one direction, whereas pressurizing the second chamber with a pressure which is higher than the air pressure in the first chamber causes the piston to move in the other, opposite direction.

According to the present disclosure, a valve arrangement is therefore provided, which is configured to connect a first chamber of the pneumatic cylinder to a compressed air supply in order thus to shift the pneumatic cylinder from the release state to the coupling state. In addition, the valve arrangement serves to connect a second chamber of the pneumatic cylinder to the compressed air supply to shift the pneumatic cylinder from the coupling state to the release state. The valve arrangement preferably also ensures that when the first chamber of the pneumatic cylinder is connected to the compressed air supply, the second chamber of the pneumatic cylinder is vented, and that when the second chamber is connected to the compressed air supply, the first chamber is vented.

In addition, the device comprises a control unit for activating the valve arrangement. According to the present disclosure, the valve arrangement of the device is designed to hold the pneumatic cylinder at least in the coupling state in the event of the failure of the control unit, in particular the failure of an electrical power supply to the control unit, and/or in the event of the failure of an electrical system which is associated with the device and serves to supply power to a component of the device.

Accordingly, the device comprises a pneumatic cylinder which is connectable to the towing vehicle and the plug connector unit in order to extend or retract the plug connector unit relative to the towing vehicle. In the release state, a connected plug connector unit is accordingly closer to the centre of gravity of the towing vehicle than in the coupling state. Therefore, after a trailer vehicle has been coupled to a towing vehicle via a fifth-wheel coupling, the pneumatic cylinder enables the plug connector end in general, for example with the plug connector unit arranged thereon, to be moved from the towing vehicle towards the trailer vehicle. In this way, the movement of the pneumatic cylinder allows an electrical and pneumatic connection to be established between the towing vehicle and the trailer vehicle. For this purpose, an alignment aid can preferably be provided on the plug connector unit, the plug connector end or a trailer plug connector unit. In this way, electrical and pneumatic connections can be established in an automated manner by means of the control unit and the valve arrangement, without an operator, in particular a driver, having to manually connect the plug connectors of the towing vehicle and the trailer vehicle to one another.

The present disclosure is based on the understanding that it is necessary for the connections to be established securely in order to guarantee safe operation. The present disclosure is further based on the understanding that the compressed air lines for an air brake system, namely a compressed air supply line and a control line, are connected by means of the ‘red’ and ‘yellow’ coupling heads, which are customarily connected to one another using a bayonet-type lock. Establishing a connection of this type in an automated manner between bayonet connectors is highly complex. According to the present disclosure, it was found that an automated connection procedure preferably takes the form of a single linear movement to establish and release the connection, this movement being considerably simpler to implement in an automated manner than a bayonet-type lock connection. However, it was also found that, in particular in safety-related applications such as an air brake system, plug connector connections of this type, established solely by means of a linear movement, require a locking mechanism, which is in turn complex to implement in an automated manner. It was accordingly found that holding the pneumatic cylinder in the coupling state can address these problems, and a secure connection can thus be established, even without a locking mechanism. Accordingly, a simple-to-implement option for establishing electrical and pneumatic connections is proposed, which can be achieved with a comparatively low level of constructional complexity. Nevertheless, the design according to the present disclosure ensures that a connection of this type is secure.

According to an embodiment, the valve arrangement is configured to hold the pneumatic cylinder in the coupling state in the event of the failure of the control unit by providing a permanent connection between the compressed air supply and the pneumatic cylinder. In the coupling state, the pneumatic cylinder is thus held securely in the coupling state. Accordingly, the valve arrangement is used to establish a stable connection, particularly preferably between the compressed air supply and the first chamber of the pneumatic cylinder, in order to hold this connection even when the valve arrangement is not activated by the control unit, namely in the event of the failure of the control unit. The permanent connection between the compressed air supply and the first chamber of the pneumatic cylinder also ensures that the plug connector end of the device is always pressed against the trailer plug connector by pressure provided by the compressed air supply, even in the case of relative movement between the plug connector end and the end of the vehicle, which can occur, for example, when cornering or driving on ramps. This ensures that the connection remains fixed in all driving situations. It is acknowledged that, in the event of the failure of the compressed air supply, the coupling state may no longer be held fully by the pressure in the first chamber alone, but the friction of the plug connectors also prevents the connections from being released, at least for a short time. In the event of the long-term failure of the compressed air supply, it is to be assumed in any case that it is hazardous to drive, and driving must come to a stop.

According to an embodiment, the compressed air supply corresponds to a compressed air supply of an air brake system of the towing vehicle. In the case of the failure of the air brake system of the vehicle, the brakes of the towing vehicle are applied in any case for safety reasons, so, even in the event of the failure of the compressed air supply, the connection between the towing vehicle and trailer vehicle only has to be held for a short time longer by the friction of the plug connectors. Preferably, however, the compressed air supply is extracted from an auxiliary consumer circuit of the air brake system, so that if a fault occurs in the device according to the present disclosure, the operation of the air brake system of the towing vehicle can be maintained.

According to an embodiment, the valve arrangement comprises a bistable cylinder activation valve with two positions for activating the pneumatic cylinder. The cylinder activation valve is preferably a bistable 4/2 valve. In a first position, which can also be referred to as the coupling position, the cylinder activation valve accordingly preferably comprises a connection between the compressed air supply and the first chamber of the pneumatic cylinder, and a connection between the second chamber and a compressed air outlet. Furthermore, in a second position of the cylinder activation valve, which can also be referred to as the release position, the second chamber of the pneumatic cylinder is connected to the compressed air supply, whereas the first chamber is connected to a compressed air outlet. The cylinder activation valve is stable in both positions, namely the coupling position and the release position, and holds this position once it has been set, even without being activated. The device can therefore be implemented reliably.

According to an embodiment, the cylinder activation valve can be activated electronically. Accordingly, the cylinder valve has components for switching between positions by means of electrical activation. Particularly preferably, two electromagnets are utilized for this purpose, wherein one of the electromagnets is arranged to switch the valve from the release position to the coupling position and the other electromagnet is configured to shift the cylinder activation valve from the coupling position to the release position. Preferably, the cylinder activation valve is activated in an electronically pilot-operated manner, so that the electromagnets only open connections between the compressed air supply and chambers of the cylinder activation valve, and the cylinder activation valve is thus shifted by the pressure of the compressed air supply.

The cylinder activation valve can therefore be activated in a suitable, automated manner via the control unit.

According to an embodiment, the valve arrangement comprises a first manual switching valve and a second manual switching valve. The manual switching valves each comprise two positions, namely a first position and a second position in each case, and can each be actuated manually. The first manual switching valve is configured to establish a connection between the compressed air supply and a first control input of the cylinder activation valve, namely in the first position, which can also be referred to as the open position, and to disconnect this connection, namely in the second position, which can also be referred to as the closed position. The second manual switching valve is configured to establish a connection between the compressed air supply and a second control input of the cylinder activation valve, namely in the first position, which can also be referred to as the open position, and to disconnect this connection, namely in the second position, which can also be referred to as the closed position. The manual switching valves provides for manually triggering a movement of the pneumatic cylinder from the coupling state to the release state or from the release state to the coupling state in the case of failure of the control unit. Therefore, if the control unit fails and the articulated lorry is nevertheless ready to be driven manually, i.e. in a non-autonomous manner, namely by a driver, the electrical and pneumatic connection can be controlled by actuating the manual switching valves. The manual switching valves are preferably arranged to be easily accessible to an operator. For example, the manual switching valves are arranged or can be arranged laterally outside the driver's cab in the region of a vehicle frame, preferably in the region between a driver's cab and a fifth-wheel coupling, on a towing vehicle.

According to an embodiment, the control unit is configured to receive sensor data and to activate the cylinder activation valve, in particular to permit or prevent activation of the cylinder activation valve, on the basis of the sensor data. Preferably, the sensor data indicate a driving state of the towing vehicle or a coupling state of the towing vehicle. Indicating a driving state preferably comprises indicating whether the towing vehicle is stationary or driving, i.e. in motion. On the basis of the sensor data indicating the driving state, for example, the valve arrangement can be prevented from being activated while the towing vehicle is in motion. Activation of the valve arrangement is accordingly only permitted when the vehicle is stationary. If the sensor data indicate a coupling state, this preferably indicates a locked or unlocked coupling state. A locked state comprises, for example, the state in which a kingpin is locked in a fifth-wheel plate. In the unlocked state, either there is no kingpin arranged in the holding region of the fifth-wheel coupling or at least the fifth-wheel coupling is not locked. The valve arrangement therefore cannot be activated, in particular in order to shift the pneumatic cylinder from the release state to the coupling state or vice versa, until the coupling state indicates a locked state. This ensures, for example, that a trailer vehicle is already connected to the towing vehicle by means of the fifth-wheel coupling and, for example, is secured against rolling away, before the pneumatic connections are connected. Otherwise, when the pneumatic connection is established, the venting of the brakes of the trailer vehicle can cause the trailer vehicle to roll away if it is not held in position in another manner. However, this is addressed by the countermeasure that the pneumatic connection cannot be established until after a connection has been established between the trailer vehicle and the towing vehicle by means of a coupling.

Activating the valve arrangement in this way by means of the control unit thus increases safety.

According to an embodiment, the sensor data are the sensor data of a pressure sensor. The pressure sensor is arranged or can be arranged in a pressure control line of an air brake system of the vehicle. The pressure control line is a control line of a brake system which serves to control the friction brakes of the towing vehicle and/or the trailer vehicle. The sensor data of the pressure sensor can therefore be used to determine whether or not the friction brakes of the towing vehicle are in active use, which provides for concluding whether the towing vehicle is stationary or driving. Alternatively or additionally, the sensor data are sensor data of a rotational speed sensor, which ascertains the rotational speed of at least one wheel, i.e. a wheel rotational speed, of the towing vehicle. The driving state can therefore likewise be ascertained via sensor data of this type. Alternatively or additionally, the sensor data are the data of a lock monitoring sensor of a coupling, in particular the fifth-wheel coupling of the towing vehicle. The coupling state can be identified using these sensor data. All these aforementioned sensors, namely pressure sensors in a pressure control line, rotational speed sensors on a wheel of the vehicle and sensors of a lock monitoring sensor of a coupling, are usually present in modern towing vehicles. It is for example already possible to retrieve the data from these existing sensors via a vehicle bus of the towing vehicle. Accordingly, the sensor data can be used by the control unit by connecting to the vehicle bus without further complexity and without adding additional sensors, in order to achieve safe operation of the device according to the present disclosure.

In addition, the present disclosure comprises a system having the device according to any one of the above-mentioned embodiments and a plug connector unit, wherein the plug connector unit preferably has at least one electrical plug connector and two pneumatic plug connectors. The plug connector unit is configured to be connected to a trailer plug connector unit.

According to an embodiment, the system comprises an autonomous control unit for autonomously controlling the towing vehicle. The autonomous control unit preferably serves as or contains the control unit of the device. The autonomous control unit is configured to autonomously connect a towing vehicle having the system to the trailer vehicle. In addition, the system is configured to autonomously release a connection with the trailer vehicle and thus park the trailer vehicle, for example at a predefined position.

According to an embodiment of the system, the latter comprises an air brake system of a vehicle. The air brake system has the compressed air supply for activating the pneumatic cylinder via the valve arrangement.

Furthermore, the present disclosure comprises a vehicle, which is preferably a towing vehicle, having a system according to any one of the above-mentioned embodiments or having a device according to any one of the above-mentioned embodiments.

In addition, the present disclosure relates to a method for automatically establishing electrical and pneumatic connections between a towing vehicle and a trailer vehicle. The method comprises shifting a pneumatic cylinder of a device according to any one of the above-mentioned embodiments from a coupling state to a release state or shifting the pneumatic cylinder from the release state to the coupling state.

According to an embodiment of the method, a valve arrangement is activated by a control unit in order to connect a first chamber of a pneumatic cylinder to a compressed air supply. This causes a piston of the pneumatic cylinder to be shifted from a release state to a coupling state, wherein the cylinder of the pneumatic cylinder is extended further outward in the coupling state. In so doing, a plug connector unit, which is connected to a plug connector end of the pneumatic cylinder, is moved relative to a towing vehicle, which is connected to a vehicle end of the pneumatic cylinder, towards a trailer vehicle. The plug connector unit comprises plug connectors which are subsequently connected to a trailer plug connector. In an embodiment, according to the method, the coupling state is held by the valve arrangement if the control unit fails and does not activate the valve arrangement. This is preferably achieved by permanently connecting the compressed air supply to the first chamber by means of the valve arrangement.

According to an embodiment, before the pneumatic cylinder is shifted from the release state to the coupling state, a sensor is used to check a driving state or coupling state of the towing vehicle, in that sensor data are received from a pressure sensor, a rotational speed sensor or a lock monitoring sensor. The pneumatic cylinder is only subsequently shifted to the coupling state if the driving state indicates that the towing vehicle is stationary and/or if a coupling state indicates that the towing vehicle is in a locked state. Alternatively or additionally, the pneumatic cylinder is only activated, in order to be shifted from the release state to the coupling state, if the control unit detects that the vehicle is stationary and/or detects that the coupling is in the locked state.

According to an embodiment, the method comprises shifting a cylinder activation valve for activating the pneumatic cylinder by means of electrical activation, in particular electronically pilot-operated activation by means of a control unit, wherein the cylinder activation valve is a bistable cylinder activation valve.

Further embodiments can be gathered from the exemplary embodiments illustrated in more detail in the figures.

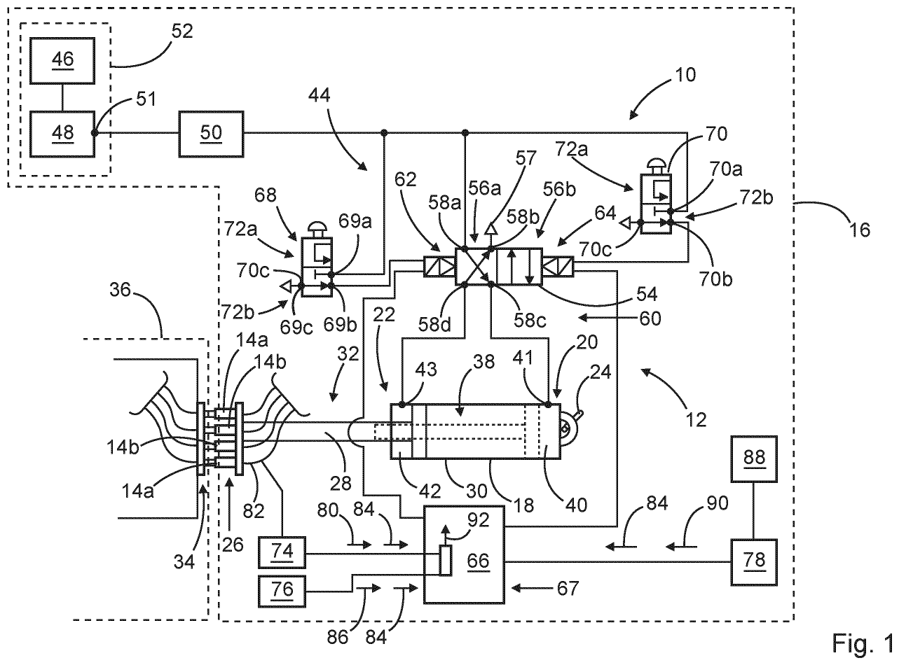

FIG. 1 shows a system 10 having a device 12 for automatically establishing electrical and pneumatic connections 14a, 14b according to an exemplary embodiment. The device 12 is a constituent part of a towing vehicle 16. The device 12 comprises a pneumatic cylinder 18 having a vehicle end 20 and a plug connector end 22. The vehicle end 20 serves to connect the pneumatic cylinder 18 to a part 24 of the towing vehicle 16. The plug connector end 22 serves to connect the pneumatic cylinder 18 to a plug connector unit 26.

Furthermore, the pneumatic cylinder 18 has a plurality of states, in which a piston 28 of the pneumatic cylinder 18 is extended to different extents out of a cylinder 30 of the pneumatic cylinder 18. In FIG. 1, a coupling state 32 of the pneumatic cylinder 18 is illustrated, in which the plug connector unit 26 is connected to a further plug connector unit 34 of a trailer vehicle 36.

The plug connector unit 26 and the trailer plug connector unit 34 are illustrated in a plugged-in, i.e. connected, state in FIG. 1. In this case, two electrical connections 14a and two pneumatic connections 14b are provided by way of example. The plug connector unit 26 of the towing vehicle 16 accordingly comprises four plug connectors and the trailer plug connector unit 34 likewise comprises four plug connectors.

In contrast, the pneumatic cylinder 18 can also assume a release state 38, which is illustrated by the broken lines of the piston 28 of the pneumatic cylinder 18 in FIG. 1. In the release state 38, the piston 28 of the pneumatic cylinder 18 is retracted further into the cylinder 30 than in the coupling state 32. Correspondingly, the plug connector unit 26, which is preferably a constituent part of the system 10 and not of the device 12, is arranged at a greater distance from the trailer plug connector unit 34 of the trailer vehicle 36.

The pneumatic cylinder 18 also has a first chamber 40 and a second chamber 42. The pneumatic cylinder 18 also has two ports 41, 43. The first port 41 serves to supply compressed air to the first chamber 40 and the second port 43 serves to supply compressed air to the second chamber 42. The two chambers 40, 42 serve to shift the pneumatic cylinder 18 from the release state 38 to the coupling state 32 or from the coupling state 32 to the release state 38. For this purpose, depending on the desired change in state, one of the two chambers 40, 42 is connected to a compressed air supply while the other chamber 40, 42 is vented.

For this purpose, a valve arrangement 44 and a compressed air supply 46 are provided. The compressed air supply 46 is supplied to the valve arrangement via a valve 48, which is, for example, a multi-circuit protection valve, in particular a four-circuit protection valve, and via a pressure-limiting valve 50 of the valve arrangement 44. In this case, the device 10 is connected to the multi-circuit protection valve via an auxiliary consumer circuit 51. In particular, the compressed air supply 46 and the valve 48 are constituent parts of an air brake system 52, which is a constituent part of the system 10 according to this exemplary embodiment, or a constituent part of the device 12 according to this exemplary embodiment. According to an embodiment, the air brake system 52 is not a constituent part of the system 10 and the device 12.

The valve arrangement 44 comprises a bistable cylinder activation valve 54. The bistable cylinder activation valve 54 has two positions 56a, 56b. In FIG. 1, the bistable cylinder activation valve 54 is illustrated in the first position 56a. In this position 56a of the bistable cylinder activation valve 54, the compressed air supply 46 is connected to the first chamber 40 of the pneumatic cylinder 18, and the second chamber 42 of the pneumatic cylinder 18 is connected to an outlet 57. The bistable cylinder activation valve 54 has four ports 58a, 58b, 58c, 58d accordingly.

By connecting the first chamber 40 to the compressed air supply 46, the first chamber 40 is filled with air and pushes the piston 28 of the pneumatic cylinder 18 out of the cylinder 30 of the pneumatic cylinder 18. In the second position 56b of the bistable cylinder activation valve 54, the ports 58a, 58d are connected to each other and the ports 58b, 58c are likewise connected to each other. This causes compressed air to be conducted from the compressed air supply 46 into the second chamber 42 via the bistable cylinder activation valve 54 and pushes the piston 28 of the pneumatic cylinder 18 back into the cylinder 30.

In the position of the bistable cylinder activation valve 54 illustrated in FIG. 1, a permanent connection 60 is provided between the compressed air supply 46 and the pneumatic cylinder 18, wherein the bistable cylinder activation valve 54 remains stable in this position without activation. The bistable cylinder activation valve 54 can be activated, namely via a first control input 62 and a second control input 64. The bistable cylinder activation valve 54 can be activated electronically by a control unit 66 via the control inputs 62, 64 in order to switch between the positions 56a, 56b. The control unit 66 corresponds, for example, to an autonomous control unit 67.

However, the control inputs 62, 64 also further serve to switch between the positions 56a, 56b by means of compressed air. For this purpose, two manual switching valves, namely a first manual switching valve 68 and a second manual switching valve 70, are provided. The manual switching valves 68, 70 each have two positions 72a, 72b, namely a first position 72a and a second position 72b. In the illustrated second position 72b of the two manual switching valves 68, 70, the control inputs 62, 64 of the bistable cylinder activation valve 54 are not activated. The second position 72b can therefore also be referred to as the closed position since no connection is established between the compressed air supply 46 and the first control input 62 or the second control input 64 of the bistable cylinder activation valve 54.

However, if the control unit 66 fails, a connection can be established between the compressed air supply 46 and the first control input 62 of the bistable cylinder activation valve 54 by actuating the first manual switching valve 68 and therefore shifting the first manual switching valve 68 to the first position 72a. The first position 72a can therefore also be referred to as the open position. The bistable cylinder activation valve 54 is then shifted to the first position 56a, as illustrated, and the pneumatic cylinder 18, if previously positioned in the release state 38, is therefore shifted to the coupling state 32. The pneumatic cylinder 18 can therefore be shifted in a corresponding manner from the coupling state 32 to the release state 38 by actuating the second manual switching valve 70. The first manual switching valve 68 has three ports 69a, 69b, 69c for this purpose and the second manual switching valve 70 has three ports 70a, 70b, 70c.

Accordingly, the valve arrangement 44 comprises the bistable cylinder activation valve 54, the first manual switching valve 68 and the second manual switching valve 70.

For safety reasons, the pneumatic cylinder 18 is preferably only activated by the control unit 66 via the valve arrangement 44 if the towing vehicle 16 and the trailer vehicle 36 are in a safe state. In order to detect a safe state of this type, the control unit 66 comprises a connection to at least one sensor. Illustrated in FIG. 1, according to this specific exemplary embodiment, are three sensors to which the control unit 66 is connected in order to detect a safe state. The sensors comprise a pressure sensor 74, a rotational speed sensor 76 and a lock monitoring sensor 78. The pressure sensor 74 is used to ascertain a pressure 80 of a pressure control line 82 of the air brake system 52 of the towing vehicle 16 and to transmit this pressure as sensor data 84 to the control unit 66. The rotational speed sensor 76 is used to ascertain a wheel rotational speed 86 of a wheel of the towing vehicle 16 and to transmit this wheel rotational speed as sensor data 84 to the control unit 66. These sensor data 84 can be used to detect a driving state, namely whether the towing vehicle 16 is stationary or driving. The lock monitoring sensor 78, which is connected to a coupling 88, namely, for example, the fifth-wheel coupling, of the towing vehicle 16, can be used to detect a coupling state 90, which indicates whether the coupling 88 is locked or unlocked and therefore whether a trailer vehicle 36 is connected to the towing vehicle 16 via the coupling 88. The coupling state 90 is also transmitted as sensor data 84 to the control unit 66. The control unit 66 then only activates the bistable cylinder activation valve 54 if, for example, the coupling state 90 indicates that a trailer vehicle 36 is securely connected to the towing vehicle 16 and, at the same time, it is ensured that a driving state 92, identified by the control unit 66 and detected from the sensor data of the pressure sensor 74 and the rotational speed sensor 76, indicates that the towing vehicle 16 is stationary.

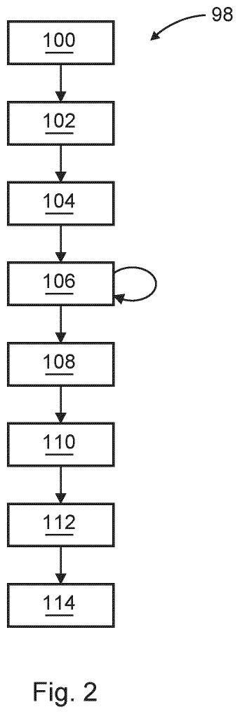

FIG. 2 shows a method 98 for automatically establishing electrical and pneumatic connections 14a, 14b between a towing vehicle 16 and a trailer vehicle 36 according to an exemplary embodiment.

In step 100, the towing vehicle 16 and the trailer vehicle 36 are not connected to each other. In step 102, a connection is established, by means of a coupling 88, between the trailer vehicle 36, in particular a kingpin of the trailer vehicle 36, and the towing vehicle 16, in particular a fifth-wheel plate of the towing vehicle 16. In step 104, a lock monitoring sensor 78 notifies a control unit 66 of a coupling state 90 indicating that the towing vehicle 16 and the trailer vehicle 36 are connected to each other via the coupling 88. Furthermore, in step 106, the control unit 66 is used to check whether the driving state 92 of the towing vehicle 16 indicates that the towing vehicle 16 is stationary. If this criterion is not fulfilled, step 106 is repeated until the towing vehicle 16 is stationary.

Subsequently, in step 108, a bistable cylinder activation valve 54 of a valve arrangement 44 is shifted from a position 56b to a position 56a by activating the valve arrangement 44 by means of the control unit 66. In this first position 56a of the bistable cylinder activation valve 54, a first chamber 40 of a pneumatic cylinder 18 is filled with compressed air, so that, in step 110, the pneumatic cylinder 18 is shifted from a release state 38 to a coupling state 32. In step 112, the coupling state 32 is reached and the pneumatic cylinder 18 presses a plug connector unit 26 against a trailer plug connector unit 34, so that a connection is established between individual plug connectors in step 114. As a result, all connections between a towing vehicle 16 and a trailer vehicle 36 are connected to each other for operation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS (PART OF THE DESCRIPTION)

10 system
12 device
14a electrical connections
14b pneumatic connections
16 towing vehicle
18 pneumatic cylinder
20 vehicle end
22 plug connector end
24 part of the towing vehicle
26 plug connector unit
28 piston
30 cylinder
32 coupling state
34 trailer plug connector unit
36 trailer vehicle
38 release state
40 first chamber
41 first port
42 second chamber
43 second port
44 valve arrangement
46 compressed air supply
48 valve
50 pressure-limiting valve
51 auxiliary consumer circuit
52 air brake system
54 bistable cylinder activation valve
56a first position
56b second position
57 outlet
58a first port
58b second port
58c third port
58d fourth port
60 permanent connection
62 first control input
64 second control input
66 control unit
67 autonomous control unit
68 first manual switching valve
69a first port
69b second port
69c third port
70 second manual switching valve
70a first port
70b second port
70c third port
72a first position
72b second position
74 pressure sensor
76 rotational speed sensor
78 lock monitoring sensor
80 pressure
82 pressure control line
84 sensor data
86 wheel rotational speed
88 coupling
90 coupling state
92 driving state
98 method
100-114 steps of the method

1. A device for automatically establishing electrical and pneumatic connections between a towing vehicle and a trailer vehicle, comprising:
a pneumatic cylinder having a vehicle end configured for connecting to a part of the towing vehicle, and having a plug connector end configured for connecting to a plug connector unit,
wherein the pneumatic cylinder has a coupling state and a release state and a piston of the pneumatic cylinder is extended further out of a cylinder of the pneumatic cylinder in the coupling state than in the release state;
a valve arrangement configured for connecting a first chamber of the pneumatic cylinder to a compressed air supply to shift from the release state to the coupling state, and configured for connecting a second chamber of the pneumatic cylinder to the compressed air supply to shift the pneumatic cylinder from the coupling state to the release state; and
a controller for activating the valve arrangement,
wherein the valve arrangement is configured to hold the pneumatic cylinder at least in the coupling state in the event of a failure of the controller.

2. The device according to claim 1, wherein the valve arrangement configured for holding the pneumatic cylinder in the coupling state in the event of the failure of the controller is configured to provide a permanent connection between the compressed air supply and the pneumatic cylinder in order to hold the pneumatic cylinder in the coupling state.

3. The device according to claim 1, wherein the compressed air supply corresponds to a compressed air supply of an air brake system, the compressed air supply being extractable in particular via an auxiliary consumer circuit of the air brake system.

4. The device according to claim 1, wherein the valve arrangement has a bistable cylinder activation valve with two positions configured for activating the pneumatic cylinder.

5. The device according to claim 4, wherein the bistable cylinder activation valve is configured to be activated electronically in an electronically pilot-operated manner.

6. The device according to claim 4, wherein the valve arrangement has a first manual switching valve and a second manual switching valve, wherein the first and second manual switching valves each have a first position and a second position and are configured to be actuated manually, and wherein the first manual switching valve is configured to connect the compressed air supply to a first control input of the cylinder activation valve and to disconnect it therefrom, and the second manual switching valve is configured to connect the compressed air supply to a second control input of the cylinder activation valve or to disconnect it therefrom.

7. The device according to claim 1, wherein the controller is configured to receive sensor data and to activate the cylinder activation valve based on the sensor data, wherein the sensor data indicates a driving state of the towing vehicle and/or the sensor data indicates a coupling state of a coupling of the towing vehicle.

8. The device according to claim 7, wherein the sensor data is the sensor data of a pressure sensor, which is connected to a pressure control line of an air brake system, or the sensor data is the sensor data of a rotational speed sensor, which ascertains a wheel rotational speed of the towing vehicle, and/or the sensor data is the sensor data of a lock monitoring sensor of a coupling of the towing vehicle.

9. A system, comprising:
the device according to claim 1; and
a plug connector unit.

10. The system according to claim 9, further comprising an air brake system.

11. The system according to claim 9, wherein the controller includes an integrated autonomous controller.

12. A vehicle, comprising the system according to claim 9.

13. A method for establishing electrical and pneumatic connections between a towing vehicle and a trailer vehicle by with the device according to claim 1, comprising:
shifting the pneumatic cylinder from the release state to the coupling state, to connect the plug connector unit to the trailer plug connector unit.

14. The method according to claim 13, wherein the method comprises:
activating, using the controller, a valve arrangement for connecting a first chamber of the pneumatic cylinder to a compressed air supply to shift from the release state to the coupling state; and
holding the coupling state even in the event of the failure of the controller by providing, with the valve arrangement, a permanent connection between the compressed air supply and the pneumatic cylinder.

15. The method according to claim 13, wherein the controller receives sensor data from a pressure sensor, a rotational speed sensor and/or a lock monitoring sensor and activates the valve arrangement based on the sensor data.

16. The device according to claim 4, wherein the cylinder activation valve is a 4/2 valve.
